(19) United States
(12) Patent Application Publication
(10) Pub. No.: US 2007/0198494 A1
(43) Pub. Date: Aug. 23, 2007

(54) APPARATUS AND METHOD FOR FACILITATING A SEARCH FOR SETS OF GEMS

(76) Inventors: Mark C. Vadon, Seattle, WA (US); Darrell S. Cavens, Seattle, WA (US); Scott Decker, Seattle, WA (US)

Correspondence Address: PERKINS COIE LLP;PATENT-SEA, P.O. BOX 1247, SEATTLE, WA, 98111-1247, US

(21) Appl. No.: 11/681,600

(22) Filed: Mar. 2, 2007

Related U.S. Application Data
(63) Continuation of application No. 11/483,414, filed on Jul. 7, 2006.
(60) Provisional application No. 60/697,673, filed on Jul. 8, 2005.

(51) Int. Cl. G06F 17/30

(52) U.S. Cl. 707/3

(57) ABSTRACT

Apparatus and method for facilitating a search for sets of gems includes, in one embodiment, a computer-readable medium having a gem search module configured to facilitate a search for a set of N matching gems (where N may be an integer of at least two). The gem search module provides a user-interface element representing a set of values of a gem attribute, receives a selection of a particular value from the set of values, and identifies a set of N matching gems as being associated with that value.

### CROSS-REFERENCE TO RELATED APPLICATION

This application claims the benefit of U.S. Provisional Application Ser. No. 60/697,673, filed on Jul. 8, 2005, the disclosure of which is incorporated herein by reference in its entirety.

### BACKGROUND

The Internet is a large collection of computers operated using a client-server computer network model. In a client-server computer network, a client computer requests information from a server computer. In response, the server computer provides the requested information to the client computer. In some instances, the server computer can be operated as a web site and can provide the requested information in the form of web pages. Server computers are often operated by large organizations, such as commercial organizations, governmental units, and educational organizations, while client computers are often operated by individuals.

With the increasing popularity of the Internet, commercial organizations have attempted to set up web sites for marketing and selling products and services. By accessing such web sites, consumers can view information regarding various products and services and can place purchase orders for particular products and services.

To exploit the capabilities and wide reach of the Internet, it is desirable to set up a web site for marketing and selling gems and gem settings. A gem refers to a precious or semi-precious material that can be used for ornamental purposes. In some instances, a gem can be cut and polished into a desired shape. Examples of gems include diamonds, pearls, rubies, sapphires, and so forth. A gem can be purchased as a stand-alone item or along with a gem setting in a jewelry item, such as a bracelet, a brooch, a set of earrings, a pendant, or a ring. A gem setting refers to a structure that can support a gem in a jewelry item. Examples of gem settings include chains, ring bands, earring bands, and so forth.

Previous attempts to market and sell products and services using the Internet have often been unsuccessful. While this lack of success has resulted from a number of factors, difficulty of use and lack of continuity and interactivity of user experience were sometimes key factors. In the case of marketing and selling gems, web site features that enhance user experience can be particularly important, since users can be quite selective when purchasing gems. Thus, it would be desirable to include web site features that facilitate a search for gems using adjustable and finely tunable search criteria. In addition, it would be desirable to include web site features that enhance continuity and interactivity of user experience upon selecting particular search results or upon adjusting search criteria.

It is against this background that a need arose to develop the apparatus and method described herein.

### BRIEF DESCRIPTION OF THE DRAWINGS

FIG. 1 illustrates a computer network that is implemented in accordance with one embodiment of the invention;

FIG. 2 illustrates a flow chart for facilitating a search for sets of N gems, according to an embodiment of the invention;

FIG. 3 illustrates an example of a M-dimensional space in which various sets of gems are represented as clusters of points; and

FIG. 4 and FIG. 5 illustrate examples of user-interface screens that can be provided by a gem search module.

A portion of this disclosure contains material to which a claim for copyright is made. The copyright owner has no objection to the facsimile reproduction by anyone of the patent document or patent disclosure (including the Figures) as it appears in the Patent and Trademark Office patent file or records, but the copyright owner reserves all other copyright rights whatsoever.

### DETAILED DESCRIPTION

As described in detail below, a computer-implemented system allows a user to find two or more sets of gemstones. For example, a user may, using the system described below, identify one diamond, and then identify a similar diamond based on at least one attribute or value, such as color or clarity.

The system may also presort gems based on certain pre-established criteria. For example, if a pair of gemstones is to fit into particular earring settings, those settings may have limitations with respect to numbers of prongs, size of gemstone, depth of gemstone, and so forth. Thus, the system identifies a subset of gemstones from a database to initially present to a user, which can then be analyzed for identifying multiple pairs for the user's consideration.

Various embodiments of the invention will now be described. The following description provides specific details for a thorough understanding and enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

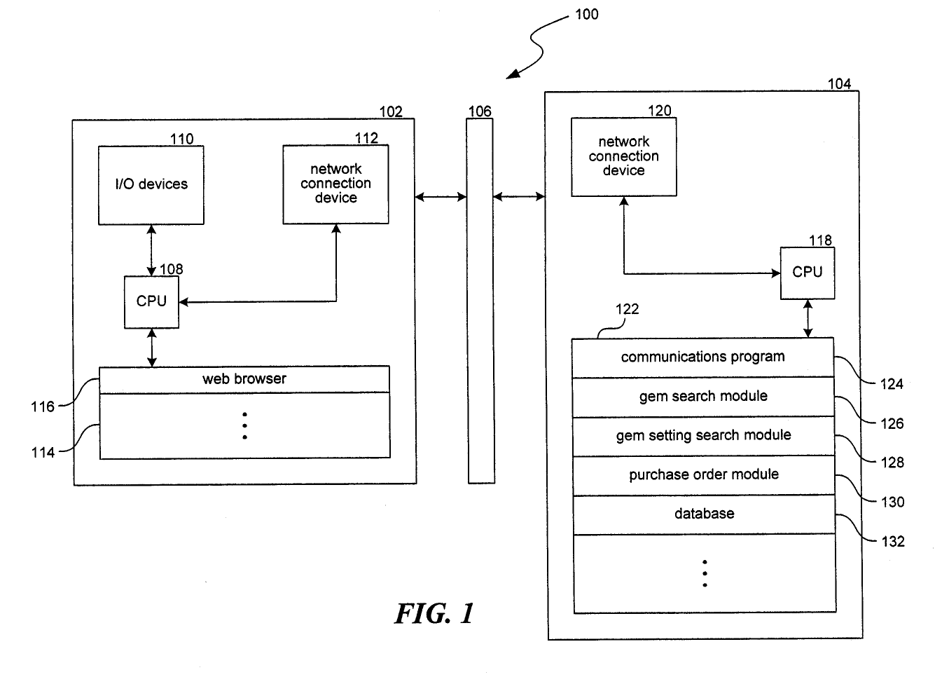

FIG. 1 and the following discussion provide a brief, general description of a suitable computing environment in which the invention can be implemented. Although not required, aspects of the invention are described in the general context of computer-executable instructions, such as routines executed by a general-purpose computer, e.g., a server computer, wireless device or personal computer. Those skilled in the relevant art will appreciate that the invention can be practiced with other communications, data processing, or computer system configurations, including: Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “computer,” “server,” and the like are generally used interchangeably herein, and refer to any of the above devices and systems, as well as any data processor.

Aspects of the invention can be embodied in a special purpose computer or data processor that is specifically programmed, configured, or constructed to perform one or more of the computer-executable instructions explained in detail herein. Aspects of the invention can also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

Aspects of the invention may be stored or distributed on computer-readable media, including magnetically or optically readable computer discs, hard-wired or preprogrammed chips (e.g., EEPROM semiconductor chips), nanotechnology memory, biological memory, or other data storage media. Indeed, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme).

FIG. 1 illustrates a computer network 100 that is implemented in accordance with an embodiment of the invention. In the illustrated embodiment, the computer network 100 is a client-server computer network that includes at least one client computer 102 and at least one server computer 104. The client computer 102 and the server computer 104 are connected by a transmission channel 106, which can be any wired or wireless transmission channel.

In the illustrated embodiment, the client computer 102 is operated by a user who wishes to obtain information regarding various gems and gem settings. Based on such information, the user may wish to purchase a jewelry item that includes a particular gem and a particular gem setting. In some instances, the user may wish to purchase a particular gem or a particular gem setting as a stand-alone item. As illustrated in FIG. 1, the client computer 102 includes conventional client computer components, including a Central Processing Unit (“CPU”) 108 that is connected to a set of one or more input/output devices 110 (e.g., a keyboard, a mouse, a video monitor, a printer, a speaker, and so forth), a network connection device 112, and a memory 114. The memory 114 stores a number of computer programs, including a web browser 116. The web browser 116 is configured to establish conventional network communications with the server computer 104 via the network connection device 112. In addition, the web browser 116 is configured to visually present information received from the server computer 104.

In the illustrated embodiment, the server computer 104 is operated as a web site for marketing and selling gems and gem settings. As illustrated in FIG. 1, the server computer 104 includes conventional server computer components, including a CPU 118 that is connected to a network connection device 120 and a memory 122. The memory 122 stores a number of computer programs, including a communication program 124. The communication program 124 is configured to establish conventional network communications with the client computer 102 via the network connection device 120. As illustrated in FIG. 1, the memory 122 also stores a set of computer programs that implement the operations described herein. In particular, the memory 122 stores a gem search module 126, a gem setting search module 128, and a purchase order module 130. Referring to FIG. 1, the various modules 126, 128, and 130 operate in conjunction with a database 132, which organizes information associated with various gems, gem settings, and jewelry items. In addition, the database 132 organizes sales information provided in connection with various purchase orders. The database 132 can be implemented as, for example, a relational database in which information can be organized using a set of tables.

Advantageously, the various modules 126, 128, and 130 are configured to enhance user experience in connection with a search for gems and gem settings as well as purchase of jewelry items that include particular gems and particular gem settings. For example, as further described below, the gem search module 126 can allow the user to readily locate a desired set of gems that are similar to one another using adjustable and finely tunable search criteria. In addition, the various modules 126, 128, and 130 are configured to enhance continuity and interactivity of user experience upon selecting particular search results or upon adjusting search criteria. For example, the various modules 126, 128, and 130 can provide a more seamless user experience by allowing elements of a web page to be updated without requiring a refresh or a reload of the web page. In such manner, the various modules 126, 128, and 130 can provide new or updated information to be visually presented using the web browser 116 while avoiding flickers or delays associated with a refresh or a reload of a web page.

With reference to FIG. 1, the gem search module 126 is configured to facilitate a search for gems. In particular, the gem search module 126 is used to search for a desired set of N gems to be included in a multiple-gem jewelry item, where N is a positive integer that can be set by default or can be specified by the user. For example, the gem search module 126 can be used to search for a single diamond to be included in an one-stone ring. As another example, the gem search module 126 can be used to search for multiple, matching diamonds to be included in a multiple-stone ring, such as a three-stone ring or a five-stone ring, or a pair of matched gems for a pair of earring settings. In some instances, the gem search module 126 can be used to search for a desired set of N gems to be purchased as a stand-alone item, such as a set of loose diamonds.

In the illustrated embodiment, the gem search module 126 provides a first set of user-interface elements to allow the user to search for sets of N gems using adjustable and finely tunable search criteria. Examples of user-interface elements include check boxes, icons, numeric or text entry fields, pop-up lists or menus, pull-down lists or menus, push buttons, radio buttons, sliding display elements, scrolling lists, spin boxes, tabs, and so forth. The gem search module 126 provides the first set of user-interface elements to the client computer 102, which displays the first set of user-interface elements using the web browser 116. Each user-interface element of the first set of user-interface elements can be associated with a particular gem attribute. A gem attribute refers to a particular property of a gem, and a value of the gem attribute refers to a particular instance of the gem attribute. Examples of gem attributes include carat weight, clarity, color, cut, length-to-width ratio, polish, price, shape, symmetry, price per carat, and so forth. Desirably, the gem search module 126 employs gem attributes that are intuitively meaningful to the user to facilitate a search for sets of N gems. In some instances, the gem search module 126 can provide tutorials to enhance user understanding of various gem attributes.

Using the first set of user-interface elements, a first set of values of various gem attributes is specified by the user. In particular, the gem search module 126 receives a user specification of the first set of values and identifies various sets of N gems that are associated with the first set of values. For example, the gem search module 126 can provide a user-interface element that represents a number of values of a gem attribute. The gem search module 126 can receive a user selection of a particular value or a particular range of values of the gem attribute and can identify various sets of N gems as having the selected value or range of values of the gem attribute. In the illustrated embodiment, the gem search module 126 performs a search of the database 132 to identify various sets of N gems. Once the various sets of N gems are identified, the gem search module 126 can indicate the various sets of N gems and can allow the user to select a particular set of N gems to be purchased.

To facilitate a search for a desired set of N gems, the gem search module 126 identifies various sets of N gems based on whether those gems match search criteria specified by the user as well as whether those gems match one another. In particular, when searching for a set of N gems to be included in a jewelry item, it can be desirable for aesthetic or other reasons that different ones of the set of N gems sufficiently match one another in terms of relevant gem attributes. For example, when searching for a center diamond and two side diamonds to be included in a three-stone ring, it can be desirable that the center diamond sufficiently match search criteria that are specified by the user, and that the two side diamonds sufficiently match the same or different search criteria that are specified by the user. At the same time, it can be desirable that the two side diamonds sufficiently match one another in terms of relevant diamond attributes, such as carat weight, color, shape, and so forth. Similar rationale and search criteria apply to selecting similar stones for a pair of earring settings. In the illustrated embodiment, the gem search module 126 identifies various sets of N gems based on search criteria specified by the user as well as a metric that indicates a degree of similarity between different gems. As further described below, an example of a metric is an Euclidean distance between gems as represented in a M-dimensional space, where M is a positive integer that represents the number of relevant gem attributes. M can be set by default or can be specified by the user.

Referring to FIG. 1, the gem setting search module 128 is configured to facilitate a search for gem settings. In particular, after a particular set of N gems has been selected, the gem setting search module 128 is used to search for a desired gem setting to be included with that set of N gems in a multiple-gem jewelry item. For example, once a particular set of multiple, matching diamonds has been selected, the gem setting search module 128 can be used to search for a ring band to be included with those diamonds in a multiple-stone ring. In some instances, the gem setting search module 128 can be used to search for a desired gem setting to be purchased as a stand-alone item.

In the illustrated embodiment, the gem setting search module 128 provides a second set of user-interface elements to allow the user to search for gem settings using adjustable and finely tunable search criteria. The gem setting search module 128 provides the second set of user-interface elements to the client computer 102, which displays the second set of user-interface elements using the web browser 116. Each user-interface element of the second set of user-interface elements can be associated with a particular gem setting attribute. A gem setting attribute refers to a particular property of a gem setting, and a value of the gem setting attribute refers to a particular instance of the gem setting attribute. Examples of gem setting attributes include chain length, metal type, price, ring size, setting style, number of prongs, depth of suitable stone for the setting, and so forth. Desirably, the gem setting search module 128 employs gem setting attributes that are intuitively meaningful to the user to facilitate a search for gem settings. In some instances, the gem setting search module 128 can provide tutorials to enhance user understanding of various gem setting attributes.

Using the second set of user-interface elements, a second set of values of various gem setting attributes is specified by the user. In particular, the gem setting search module 128 receives a user specification of the second set of values and identifies various gem settings that are associated with the second set of values. For example, the gem setting search module 128 can provide a user-interface element that represents a number of values of a gem setting attribute. The gem setting search module 128 can receive a user selection of a particular value or a particular range of values of the gem setting attribute and can identify various gem settings as having the selected value or range of values of the gem setting attribute. In some instances, the gem setting search module 128 can identify various gem settings based on whether those gem settings sufficiently match a particular set of N gems that has been selected by the user. In the illustrated embodiment, the gem setting search module 128 performs a search of the database 132 to identify various gem settings. Once the various gem settings are identified, the gem setting search module 128 can indicate the various gem settings and can allow the user to select a particular gem setting to be purchased.

To facilitate a selection of a desired gem setting, the gem setting search module 128 provides visual representations of various gem settings that are identified. In the illustrated embodiment, the gem setting search module 128 performs a search of the database 132 to retrieve the visual representations. The gem setting search module 128 then provides the visual representations to the client computer 102, which displays the visual representations using the web browser 116. For example, the visual representations can include images of respective ones of the various gem settings. Based on the visual representations, the user can visually compare different gem settings to select a particular gem setting. To provide the user with a sense of scale, the visual representations can include images of respective ones of the various gem settings along with a particular set of N gems that has been selected by the user. To facilitate further exploration of a particular gem setting, the visual representations can also include images, illustrations, graphics, videos, animations, etc. that correspond to different views of that gem setting. In some instances, the gem setting search module 128 can allow the user to select a particular view to be displayed, thus enhancing interactivity. Examples of views include those having different magnification factors, such as an initial view, an enlarged view, a reduced view, and so forth. Additional examples of views include those having different orientations, such as a perspective view, a side view, a top view, and so forth. Desirably, at least one of the visual representations can correspond to a particular view of that gem setting as being worn on a human body part, such as an ear, a hand, a finger, a neck, and so forth.

Referring to FIG. 1, the purchase order module 130 is configured to facilitate purchase of jewelry items. In particular, the purchase order module 130 is used to purchase a multiple-gem jewelry item that includes a particular set of N gems and a particular gem setting that have been selected by the user. For example, once a particular set of multiple, matching diamonds and a particular ring band have been selected, the purchase order module 130 can be used to purchase a multiple-stone ring that includes those diamonds and that ring band. Likewise, once a particular set of multiple, matching diamonds and a particular pair of earring settings have been selected, the purchase order module 130 can be used to purchase a pair of earrings with those diamonds and earring settings. In some instances, the purchase order module 130 can be used to purchase a particular set of N gems or a particular gem setting as a stand-alone item.

In the illustrated embodiment, the purchase order module 130 provides a third set of user-interface elements to allow the user to specify relevant information in connection with a purchase of a jewelry item. The purchase order module 130 provides the third set of user-interface elements to the client computer 102, which displays the third set of user-interface elements using the web browser 116. The third set of user-interface elements can be used to specify various types of sales information, such as customer name, customer address, method of payment, credit card number, items to be purchased, quantity of items to be purchased, and so forth. Based on such sales information, the purchase order module 130 identifies and processes a purchase order of the jewelry item. In the illustrated embodiment, the purchase order module 130 incorporates sales information in the database 132 in connection with processing of the purchase order.

In one embodiment, the various modules 126, 128, and 130 are implemented in accordance with a callback model, such as an asynchronous callback model, in which user input at the client computer 102 invokes operation of one or more of the various modules 126, 128, and 130 at the server computer 104. Unlike a postback model, such a callback model allows new or updated information to be provided and visually presented using the web browser 116 while avoiding flickers or delays associated with a refresh or a reload of a web page. Such a callback model can provide other benefits, such as allowing light-weight client implementations and enhanced compatibility across different types of web browsers. Thus, for example, the gem search module 126 can be implemented in accordance with an asynchronous callback model in which user input at the client computer 102 produces a request that is conveyed asynchronously to the server computer 104. The request can invoke operation of the gem search module 126, which can provide new or updated information to be visually presented using the web browser 116 without a refresh or a reload of a web page. In particular, this information can be used to modify or update a relevant portion of the web page without having to refresh or reload the entire web page in response to the user input. In such manner, the gem search module 126 can provide a more seamless user experience upon selecting particular search results or upon adjusting search criteria.

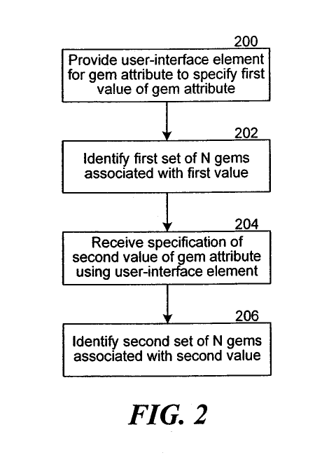

The foregoing provides an overview of an embodiment of the invention. Attention next turns to FIG. 2, which illustrates a flow chart for facilitating a search for sets of N gems, according to an embodiment of the invention.

The first operation illustrated in FIG. 2 is to provide a user-interface element for a gem attribute (block 200). In the illustrated embodiment, a gem search module (e.g., the gem search module 126) provides the user-interface element to facilitate a search for a desired set of N gems to be included in a multiple-gem jewelry item. In particular, the user-interface element represents a number of values of the gem attribute and is used to specify a first value included in those values.

As illustrated in FIG. 2, the second operation is to identify a first set of N gems associated with the first value of the gem attribute (block 202). In the illustrated embodiment, the gem search module produces a first search query based on the first value and identifies various sets of N gems as responsive to the first search query. Here, the various sets of N gems that are identified include the first set of N gems. As described previously, the gem search module can perform a search of a database (e.g., the database 132) to identify the various sets of N gems.

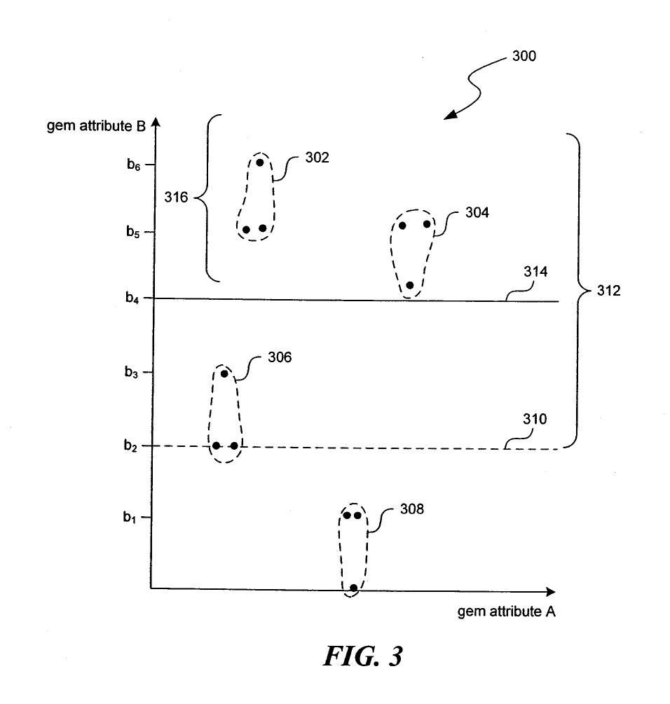

FIG. 3 illustrates just one example of graphically representing sets of similar gems. As shown in FIG. 3, an example of an M-dimensional space 300 includes various sets of gems represented as clusters of points 302, 304, 306, and 308, according to this one embodiment of the invention. As illustrated in FIG. 3, the M-dimensional space 300 includes two dimensions, which are associated with gem attribute A and gem attribute B, respectively. Here, gem attribute A can take on continuous values within a particular range of values (e.g. price or carat), while gem attribute B can take on discrete values within a particular range of values (e.g., clarity or color). While two dimensions are illustrated in FIG. 3, it is contemplated that the number of dimensions included in the M-dimensional space 300 can be more or less than two for other implementations.

Referring to FIG. 3, each gem is represented as a point in the M-dimensional space 300, such that the point has coordinates corresponding to values of gem attributes A and B for that gem. When represented in such a manner, gems that are similar to one another in terms of both gem attributes A and B will appear as a cluster of points in the M-dimensional space 300. As illustrated in FIG. 3, each of the clusters of points 302, 304, 306, and 308 includes three points representing three gems that are similar to one another in terms of gem attributes A and B. In particular, points within a particular one of the clusters of points 302, 304, 306, and 308 are closely spaced with respect to one another in terms of Euclidean distances between those points. On the other hand, points within different ones of the clusters of points 302, 304, 306, and 308 are spaced farther apart with respect to one another in terms of Euclidean distances between those points. Thus, by using Euclidean distances between points as a metric, the gem search module can identify the clusters of points 302, 304, 306, and 308, thus allowing identification of various sets of gems that are similar to one another within their respective sets.

In some instances, it can be desirable to identify two or more sets of gems that are similar to one another in terms of gem attribute A and gem attribute B (although more than two attributes may be employed). When represented in the M-dimensional space 300, two sets of gems that are similar to one another will appear as neighboring clusters of points. In particular, a centroid can be defined for each of the clusters of points 302, 304, 306, and 308. Centroids for neighboring ones of the clusters of points 302, 304, 306, and 308 are closely spaced with respect to one another in terms of Euclidean distances between those centroids. On the other hand, centroids for non-neighboring ones of the clusters of points 302, 304, 306, and 308 are spaced farther apart with respect to one another in terms of Euclidean distances between those centroids. Thus, by using Euclidean distances between centroids as a metric, the gem search module can identify neighboring ones of the clusters of points 302, 304, 306, and 308, thus allowing identification of different sets of gems that are similar to one another.

As illustrated in FIG. 3, an initial search criterion is represented as a line 310 in the M-dimensional space 300. Here, the initial search criterion is used to specify an initial lower limit of gem attribute B that is at least b2. While a single line is illustrated in FIG. 3, it is contemplated that the initial search criterion can be represented as multiple lines for other implementations. For example, the initial search criterion can be represented as a pair of lines to specify an initial lower limit and an initial upper limit of gem attribute B. It is also contemplated that the initial criterion can be represented as a curve or any other regularly shaped or irregularly shaped boundary. As illustrated in FIG. 3, the line 310 defines an initial region of interest 312 within the M-dimensional space 300. In such manner, the gem search module can identify the clusters of points 302, 304, and 306 as located within the initial region of interest 312, thus allowing identification of various sets of gems that match the initial search criterion.

Turning back to FIG. 2, once the various sets of N gems are identified, the gem search module indicates the various sets of N gems and allows the user to specify a particular set of N gems to be purchased. In some instances, the gem search module can provide information regarding a particular set of N gems to allow the user to make an educated purchase of that set of N gems. For example, in response to a user selection of the first set of N gems, the gem search module can indicate values of various gem attributes for the first set of N gems. The gem search module can also provide information regarding two or more sets of N gems to allow a comparison of those sets of N gems. For example, the gem search module can indicate respective values of various gem attributes for those sets of N gems. In the illustrated embodiment, the gem search module can also allow fine tuning of a search for sets of N gems as described below.

As illustrated in FIG. 2, the third operation is to receive a user specification of a second value of the gem attribute (block 204). In the illustrated embodiment, the gem search module receives the user specification of the second value, which is specified using the user-interface element.

The fourth operation illustrated in FIG. 2 is to identify a second set of N gems associated with the second value of the gem attribute (block 206). In the illustrated embodiment, the gem search module produces a second search query based on the second value and identifies various sets of N gems as responsive to the second search query. Here, the various sets of N gems that are identified include the second set of N gems. As described previously, the gem search module can perform a search of the database to identify the various sets of N gems.

Referring to FIG. 3, an adjusted search criterion is represented as a line 314 in the M-dimensional space 300. Here, the line 314 is spaced apart with respect to the line 310 and is used to specify an adjusted lower limit of gem attribute B that is at least b4. As illustrated in FIG. 3, the line 314 defines an adjusted region of interest 316 within the M-dimensional space 300. In such manner, the gem search module can identify the clusters of points 302 and 304 as located within the adjusted region of interest 316, thus allowing identification of various sets of gems that match the adjusted search criterion.

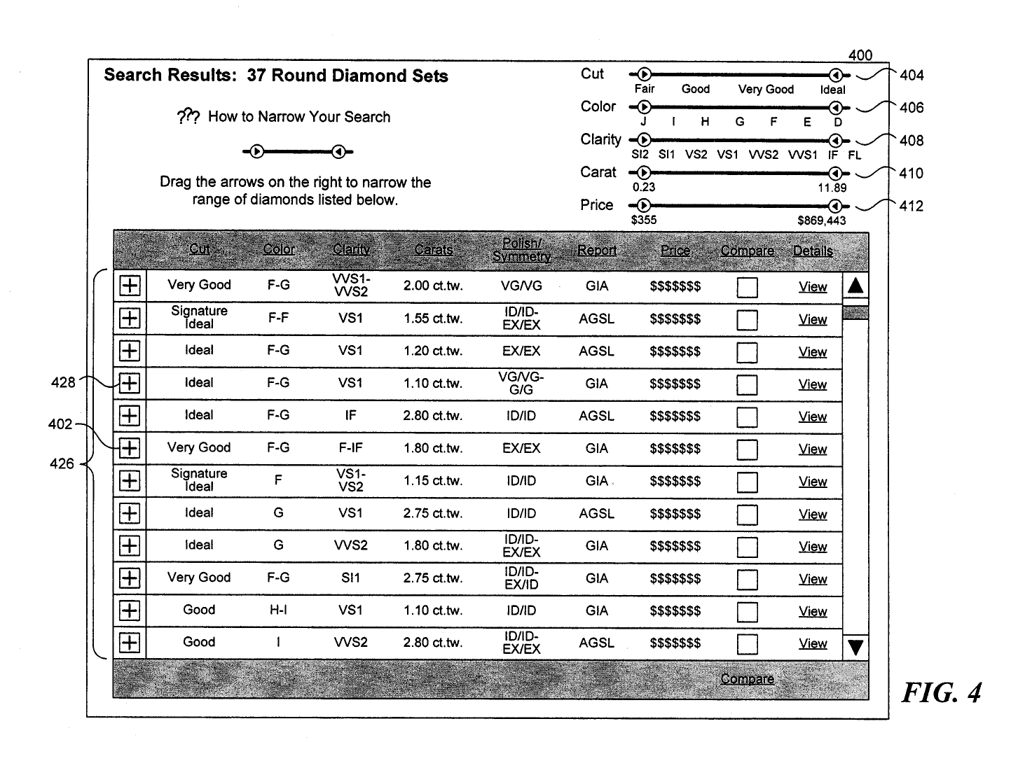

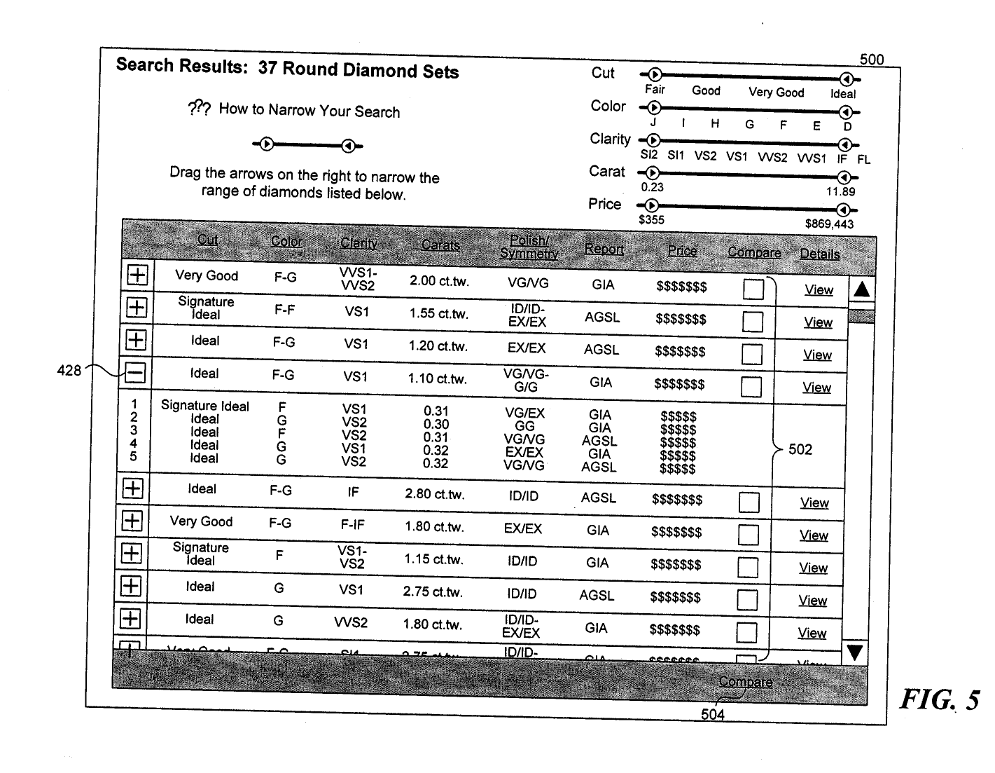

FIG. 4 and FIG. 5 illustrate examples of user-interface screens 400 and 500 that can be provided by a gem search module (e.g., the gem search module 126), according to an embodiment of the invention. In the illustrated embodiment, the user-interface screens 400 and 500 can be provided as web pages that are displayed using a web browser (e.g., the web browser 116).

Referring to FIG. 4, the user-interface screen 400 is used to search for a desired set of five round diamonds to be included in a multiple-stone jewelry item. In the present example, 37 sets of round diamonds are initially identified. (Note that the initial set of diamonds may be pre-filtered based on particular criteria, such as a setting previously selected, and limitations of that setting.) As illustrated in FIG. 4, various identified round diamonds are grouped as matching sets within respective rows in a search results portion 402 of the user-interface screen 400. Here, the search results portion 402 includes a set of expand buttons 426 that allow the user to further explore a particular set of round diamonds. By selecting a particular one of the set of expand buttons 426, such as an expand button 428, values of various diamond attributes can be indicated for a particular set of round diamonds.

As illustrated in FIG. 4, the user-interface screen 400 includes user-interface elements 404, 406, 408, 410, and 412, which can be used to fine tune a search for sets of round diamonds. The user-interface element 404 allows the user to specify a range of values of a cut of a diamond. The cut of a diamond refers to the quality of processing that is used to shape the diamond and can be measured based on the diamond's roundness, depth, width, and uniformity of its facets. As illustrated in FIG. 4, the cut of a diamond can take on discrete values that range from, for example, fair cut to ideal cut. The user-interface element 406 allows the user to specify a range of values of a color of a diamond. The color of a diamond refers to the ability of the diamond to reflect light of various wavelengths and can take on discrete values that range from, for example, J (i.e., color slightly detectable) to D (i.e., no traces of color detectable by an expert gemologist). The user-interface element 408 allows the user to specify a range of values of a clarity of a diamond. The clarity of a diamond refers to the amount of trace minerals, fractures, or other imperfections present in the diamond and can take on discrete values that range from, for example, SI2 (i.e., imperfections detectable under 10 times magnification and slightly detectable to unaided eye) to FL (i.e., no imperfections detectable under 10 times magnification). The user-interface element 410 allows the user to specify a range of values of a carat weight of a diamond, such as a range of values within 0.23 and 11.88 carats. And, the user-interface element 412 allows the user to specify a price range, such as a price range within $355 and $869,443.

In the present example, each of the user-interface elements 404, 406, 408, 410, and 412 is provided as a sliding display element that includes a bar and a pair of sliders. Each pair of sliders can be independently displaced to fine tune a search for sets of round diamonds. In the event that any of the sliders is displaced to adjust search criteria, different sets of round diamonds can be identified based on the adjusted search criteria. These different sets of round diamonds can form a subset of the previously identified sets of round diamonds. Advantageously, the user-interface screen 400 can provide a more seamless user experience by allowing the search results portion 402 to be updated without requiring a refresh or a reload of the user-interface screen 400. (Alternatively or additionally, some or all screens may be refreshed with a minimal reload.) Moreover, the user-interface screen 400 can provide enhanced interactivity by allowing the user to quickly see the impact that the displacement of any of the sliders has on price and availability of sets of round diamonds. In turn, such enhanced interactivity allows the user to easily make trade-offs in various diamond attributes to locate a desired set of round diamonds.

As illustrated in FIG. 4, the user-interface elements 404, 406, and 408 represent linear scales of values of the cut, color, and clarity of a diamond, respectively, while the user-interface elements 410 and 412 represent nonlinear scales of values of the carat weight and price of a diamond, respectively. A nonlinear scale of values refers to an arrangement of values, such that various intervals in the arrangement can be associated with varying differences in values. In some instances, a nonlinear scale of values can be envisioned as an axis of values in which a set of marks are placed at regularly spaced intervals along the axis and in which various intervals along the axis can be associated with varying differences in values. An example of a nonlinear scale of values is a logarithmic scale of values. Unlike a linear scale of values, a nonlinear scale of values of a diamond attribute can be tailored to allow a greater or lesser variation of values of the diamond attribute at various intervals in the nonlinear scale of values. For example, the nonlinear scale of values can be tailored to provide a greater or lesser variation of values of the diamond attribute at a particular interval based on availability of diamonds at that interval, thus allowing a “sweet spot” to be created. Moreover, compared with a linear scale of values, a nonlinear scale of values of a diamond attribute can allow a more compact representation of a range of values of the diamond attribute. Such compact representation can be particularly desirable for diamond attributes that can take on a wide range of values, such as carat weight and price. As illustrated in FIG. 4, the user-interface element 410 includes a bar 414, which represents a nonlinear scale of values of the carat weight of a diamond, and a pair of sliders 416 and 418. Either, or both, of the sliders 416 and 418 can be displaced by, for example, a click and drag operation to specify various ranges of values included in the nonlinear scale of values. The user-interface element 412 includes a bar 420, which represents a nonlinear scale of values of the price of a diamond, and a pair of sliders 422 and 424. Either, or both, of the sliders 422 and 424 can be displaced to specify various ranges of values included in the nonlinear scale of values. While horizontal sliders are shown, an alternative embodiment may employ vertical sliders, or other user-interface configurations.

Turning next to FIG. 5, the user-interface screen 500 is illustrated in which the expand button 428 is selected to further explore a particular set of round diamonds. In particular, by selecting the expand button 428, values of various diamond attributes are indicated for each round diamond of that set of round diamonds. As illustrated in FIG. 5, the user-interface screen 500 includes a set of check boxes 502 that allow the user to select two or more sets of round diamonds for comparison purposes. Once two or more sets of round diamonds have been selected, an option 504 labeled as “compare” can be selected, and respective values of various diamond attributes for the selected sets of round diamonds can be indicated. Based on a comparison of two or more sets of round diamonds, the user can select a particular set of round diamonds to be included in a jewelry item.

It should be recognized that the embodiments of the invention described above are provided by way of example, and various other embodiments are encompassed by the invention. For example, while the various modules 126, 128, and 130 and the database 132 are illustrated in FIG. 1 as residing in the server computer 104, it is contemplated that such configuration is not required in all implementations. In particular, one or more of the various modules 126, 128, and 130 and the database 132 can reside in a separate server computer (not illustrated in FIG. 1) that is connected to the server computer 104. Alternatively, or in conjunction, one or more of the various modules 126, 128, and 130 and the database 132 can reside in the client computer 102. In particular, one or more of the various modules 126, 128, and 130 and the database 132 can be downloaded to the client computer 102 in an encrypted or compressed format. In addition, while not illustrated in FIG. 1, a database management program can be provided to create the database 132 as well as to facilitate access to the database 132.

As another example, it is contemplated that the various modules 126, 128, and 130 can store status information to reflect selections previously specified by a user. Based on such status information, the various modules 126, 128, and 130 can allow the user to return to a web page as previously viewed, so that the user can resume a search for gems or gem settings using that web page. As a further example, it is contemplated that the various modules 126, 128, and 130 can include features to automatically resize or maximize web pages based on a particular web browser setting, such as a resolution setting or a window size.

An embodiment of the invention relates to a computer storage product with a computer-readable medium having executable instructions or computer code thereon for performing various computer-implemented operations. The term “computer-readable medium” is used herein to include any medium that is capable of storing or encoding a sequence of executable instructions or computer code for performing the operations described herein. The media and computer code can be those specially designed and constructed for the purposes of the invention, or can be of the kind well known and available to those having ordinary skill in the computer software arts. Examples of computer-readable media include: magnetic media such as hard disks, floppy disks, and magnetic tape; optical media such as Compact Disc-Read Only Memories (“CD-ROMs”) and holographic devices; magneto-optical media such as floptical disks; and hardware devices that are specially configured to store and execute program code, such as Application-Specific Integrated Circuits (“ASICs”), Programmable Logic Devices (“PLDs”), Read Only Memory (“ROM”) devices, and Random Access Memory (“RAM”) devices. Examples of computer code include machine code, such as produced by a compiler, and files containing higher level code that are executed by a computer using an interpreter. For example, an embodiment of the invention may be implemented using Java, C++, or other object-oriented code, such as object-oriented programming language and development tools. Additional examples of computer code include encrypted code and compressed code. Also, certain embodiments of the invention may be implemented using client-side code or scripting languages, such as Dynamic Hypertext Markup Language (“DHTML”) or client-side JavaScript. Other embodiments of the invention may be implemented using server-side code or scripting languages, such as Active Server Page (“ASP”), Asynchronous Remotely Generated Script (“ARGS”), ColdFusion, JavaServer Page (“JSP”), Server-Side Include (“SSI”), Practical Extraction and Report Language (“Perl”), PHP Hypertext Preprocessor (“PHP”), Python, or server-side JavaScript. Further embodiments of the invention may be implemented using Asynchronous JavaScript Technology and XML (“AJAX”). These are only examples, and may other architectures, programming/scripting languages, etc., may be employed, as those skilled in the art will appreciate.

Another embodiment of the invention can be downloaded as a computer program product, which can be transferred from a remote computer (e.g., a server computer) to a requesting computer (e.g., a client computer or a different server computer) by way of data signals embodied in a carrier wave or other propagation medium via a transmission channel. Accordingly, as used herein, a carrier wave can be regarded as a computer-readable medium.

Another embodiment of the invention can be implemented in hardwired circuitry in place of, or in combination with, computer code.

A practitioner of ordinary skill in the art requires no additional explanation in developing the apparatus and method described herein but may nevertheless find some helpful guidance by examining the patent applications of Elowitz et al., U.S. patent application Ser. No. 10/452,789, entitled “Apparatus and Method for Facilitating a Search for Gems” and filed on May 30, 2003; and Vadon et al., U.S. patent application Ser. No. 11/101,159, entitled “Apparatus and Method for Facilitating a Search for Gem Settings” and filed on Apr. 6, 2005; the disclosures of which are incorporated herein by reference in their entireties.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the invention provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of the above Detailed Description. While the above description describes certain embodiments of the invention, and describes the best mode contemplated, no matter how detailed the above appears in text, the invention can be practiced in many ways. Details of the system may vary considerably in its implementation details, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

I/We claim:

1. A computer-readable medium containing instructions to be implemented by a computer, wherein the instructions assist in identifying gems in a database of gems, the computer-readable medium comprising:
a gem search module configured to facilitate a search for a set of N matching gems, wherein N is an integer that is at least two, and wherein the gem search module is configured to:
provide a first user-interface element representing a first set of values of a gem attribute;
receive a user-input selection of a first value from the first set of values; and,
query the database of gems and identify the set of N matching gems as being associated with the first value.

2. The computer-readable medium of claim 1, wherein the multiple-gem jewelry item corresponds to a multiple-stone jewelry item, and the set of N matching gems corresponds to a set of N matching diamonds to be included in the multiple-stone jewelry item.

3. The computer-readable medium of claim 1, wherein the gem attribute corresponds to one of carat weight, clarity, color, cut, length-to-width ratio, polish, price, price per carat, depth, table, fluorescence, shape, and symmetry.

4. The computer-readable medium of claim 1, wherein the gem search module is configured to identify the set of N matching gems based on a search criterion corresponding to the first value.

5. The computer-readable medium of claim 4, wherein the gem search module is further configured to identify the set of N matching gems based on a metric that indicates a degree of similarity between gems included in the set of N matching gems.

6. The computer-readable medium of claim 5, wherein the metric indicates the degree of similarity between the gems with respect to at least one gem attribute.

7. The computer-readable medium of claim 1, further comprising:
a gem setting search module configured to facilitate a search for a gem setting to be included in the multiple-gem jewelry item, wherein the gem setting search module is configured to:
provide a second user-interface element representing a second set of values of a gem setting attribute;
receive a selection of a second value from the second set of values; and
identify the gem setting as being associated with the second value.

8. The computer-readable medium of claim 7, wherein the gem setting attribute corresponds to one of chain length, metal type, price, number of prongs, acceptable gem depth, ring size, and setting style.

9. A system configured to facilitate a search for gems, the system comprising:
a data store containing multiple data elements, each data element defining one of multiple gems, wherein each gem has at least a first criterion; and
a data processor configured to query the data store, and further configured to:
define a metric that indicates a degree of similarity between gems, wherein the gems are represented by corresponding data elements in the data store;
facilitate specification of a first search criterion for the gems based on the first criterion; and
identify a first subset of the gems from the data store based on the metric and the first search criterion.

10. The system of claim 9, wherein the metric indicates a degree of similarity between the gems with respect to a set of gem attributes.

11. The system of claim 10, wherein the set of gem attributes includes at least one of carat weight, color, and shape.

12. The system of claim 10, wherein the metric corresponds to Euclidean distances between the gems as represented in a M-dimensional space, and M corresponds to a number of gem attributes included in the set of gem attributes.

13. The system of claim 12, wherein M is an integer that is at least two.

14. The system of claim 12, wherein the first search criterion defines a first region of interest within the M-dimensional space.

15. The system of claim 14, wherein the first subset of the gems corresponds to a first cluster of points within the first region of interest.

16. The system of claim 12, wherein the data processor is further configured to:
facilitate specification of a second search criterion for the gems; and
identify a second subset of the gems from the data store based on the metric and the second search criterion.

17. The system of claim 16, wherein the second search criterion defines a second region of interest within the M-dimensional space.

18. The system of claim 17, wherein the second subset of the gems corresponds to a second cluster of points within the second region of interest.

19. A computer-implemented method of facilitating a search for gems, comprising:
identifying a first plurality of gems based on a first search criterion; and
indicating the first plurality of gems by grouping together particular ones of the first plurality of gems that substantially match one another with respect to a set of gem attributes.

20. The computer-implemented method of claim 19, wherein the set of gem attributes includes at least two different ones of carat weight, clarity, color, cut, length-to-width ratio, polish, shape, and symmetry.

21. The computer-implemented method of claim 19, further comprising:
identifying a second plurality of gems based on a second search criterion; and
indicating the second plurality of gems by grouping together particular ones of the second plurality of gems that substantially match one another with respect to the set of gem attributes.

22. The computer-implemented method of claim 21, wherein the second plurality of gems corresponds to a subset of the first plurality of gems.

23. The computer-implemented method of claim 21, wherein the indicating the first plurality of gems includes providing a web page that indicates the first plurality of gems, and the indicating the second plurality of gems includes updating the web page without a refresh of the web page.
